(19) United States
(12) Patent Application Publication
(10) Pub. No.: US 2014/0136278 A1
(43) Pub. Date: May 15, 2014

(54) COMPETITIVE PRICE ALERT SYSTEM WITH COMPETITIVE PRICE RULES ENGINE

(71) Applicant: Homer TLC, Inc., Wilmington, DE (US)

(72) Inventor: Rodrigo Pierzchalski Carvalho, Foster City, CA (US)

(73) Assignee: Homer TLC, Inc., Wilmington, DE (US)

(21) Appl. No.: 13/841,136

(22) Filed: Mar. 15, 2013

Related U.S. Application Data
(60) Provisional application No. 61/727,053, filed on Nov. 15, 2012.

(51) Int. Cl. G06Q 30/02

(52) U.S. Cl. CPC G06Q 30/0201
USPC 705/7.29

(57) ABSTRACT

Price alerts relating to competitor products are transmitted to a user. A user provides product information, which is used to generate a product set. The products in the product set are used to generate a competitor set, which includes competitors that offer products in the product set. A rule set is generated that includes rules applied to the products and the competitors. A search is performed for the products against the competitors to determine if a rule has been broken. If so, an alert is transmitted to the user. In some implementations, instructions are also transmitted to correct the broken rule. Steps to correct the broken rule may include lowering the price offered by the user for the product.

### CROSS-REFERENCE TO RELATED APPLICATIONS

This application claims priority to U.S. Provisional Patent Application No. 61/727,053, filed Nov. 15, 2012, and entitled “COMPETITIVE PRICE ALERT SYSTEM WITH COMPETITIVE PRICE RULES ENGINE,” which is hereby incorporated by reference in its entirety. This application is also related to co-pending, commonly assigned U.S. patent application Ser. No. ______ [having attorney docket no. HOMR.PO476.US], filed Mar. 15, 2013, and entitled “SYSTEM AND METHOD FOR AUTOMATIC WRAPPER INDUCTION BY APPLYING FILTERS,” U.S. patent application Ser. No. ______ [having attorney docket no. HOMR.PO477.US], filed Mar. 15, 2013, and entitled “SYSTEM AND METHOD FOR AUTOMATIC WRAPPER INDUCTION USING TARGET STRINGS,” and U.S. patent application Ser. No. ______ [having attorney docket no. HOMR.PO478.US], filed Mar. 15, 2013, and entitled “SYSTEM AND METHOD FOR AUTOMATIC PRODUCT MATCHING,” the disclosures of which are incorporated by reference in their entirety. Copies of U.S. patent application Ser. No. ______ [having attorney docket no. HOMR.PO476.US], Ser. No. ______ [having attorney docket no. HOMR.PO477.US], and Ser. No. ______ [having attorney docket no. HOMR.PO478.US], are attached hereto as Appendices A, B, and C, respectively.

### TECHNICAL FIELD

This disclosure relates generally to the field of pricing retail items and, particularly to competitive intelligence relating to retail items.

### BACKGROUND

Competitive intelligence, as it relates to pricing, has been an important aspect of the retail business for decades. Today, via the internet consumers have tools that allow them to compare prices across thousands of retailers in seconds. To be competitive, retailers today must: i) know how much their competitors are charging for the goods that they carry and ii) be able to act on this information.

Many retailers carry a very large number of products on their catalog, often times in excess of 100,000 different stock keeping units (SKUs) associated with different products. Each SKU is often sold by many different competitors at different prices. However, competitors may change their prices for products at any time, which makes it more difficult to determine the pricing of the products at different retailers.

Different retails selling a plurality of products at different prices creates a massive amount of information to be analyzed on a timely manner. Because of the massive amount of information associated with competitive intelligence, often times retailers find themselves with product prices that are either too high or too low. A retailer having sub-optimal product pricing can results in either low sales or poor margins.

Currently, to determine competitive pricing data companies: (1) load competitive pricing data for known retailers on a spreadsheet and manually perform pricing analysis, or (2) load competitive pricing data for known retailers on a data-mining or business intelligence tool and manually perform pricing analysis manually.

These methods are inefficient and inadequate because it requires a person to be running these analyses on an on-going basis, and competitive pricing may only be performed for retailers that are known. Given the high volume and frequency of online price changes for products and the growing number of retailers, these methods are ineffective and inefficient. To this end, there is a need for improved systems and methods for competitive intelligence relating to pricing in the retail industry.

### SUMMARY

Embodiments as described herein relate to pricing of products in the retail industry. A system may determine web pages for competitors that include relevant products to a customer of the system. One example of such a customer may be a business entity. One example of a business entity can be a retailer. This retailer maybe selling a product and is interested in information relating to that product or similar ones from its competitors, including known and unknown competitors. These competitors may have a presence on the Internet. The system may be configured to pull information associated with products or product types from an unbound number of domains on the Internet. Examples of information associated with a product may include name, description, product attributes, SKU, price, image, etc. These competitors as well as their domains and websites may or may not be known by a customer requesting the information.

In this disclosure, the term “domain” is used in the context of the hierarchical Domain Name System (DNS) of the Internet. Those skilled in the art appreciate that the DNS refers to a hierarchical naming system for computers or any resource connected to the Internet. A network that is registered with the DNS has a domain name under which a collection of network devices are organized. Today, there are hundreds of millions of websites with domain names and content on them. As the number of websites continues to grow, pulling information associated with a product or products from an unbound number of domains on the Internet can be a very complex, tedious, and complicated process.

Embodiments disclosed herein can leverage wrapper induction and wrapper infection methodologies disclosed in Appendix A and Appendix B attached herewith to automate a data mining process across unbounded domains. Additionally, because each competitor may describe or define a product in different ways, it may be desirable or necessary to determine which products sold by different competitors refer to the same product. Embodiments disclosed herein can also leverage a novel approach disclosed in Appendix C attached herewith to match a product or product type of interest with product information crawled from the Internet. This matching process can help to ensure that any price or feature comparison made between a predefined product/product type and products/product types being sold by different competitors on the Internet are the same and/or relevant. Appendices A, B, and C are hereby incorporated by reference in their entireties.

In embodiments disclosed herein, a system is operable to obtain or otherwise gain knowledge on the products that competitors are selling and each competitor's pricing of the products. The system includes a user interface through which a customer can create price alerts and price rules associated with a profit margin for a product. The system may also include a rules engine and an alert module. The rules engine may be configured to process these custom rules and the alert module may be configured to generate an alert when a competitor's pricing on the product violates a rule set up by the customer. The customer may or may not have prior knowledge of such a competitor.

In one embodiment, the user interface may include a dashboard through which an authorized user of a customer may define different product sets, competitor sets, and alerts and rules associated with any desired product. Product sets may be associated with a type of product, such as “all digital cameras” products and/or a more specific grouping of types of digital cameras. Competitor sets may be associated with a set of competitors that are relevant to a type of product. In one embodiment, a retailer set may include all the competitors that are relevant to “digital cameras.” The competitor sets may define a type of product sold by a set of competitors. In one embodiment, a retailer may define a set as “all ACME digital cameras.” Therefore, any desired set of competitor's products may be defined by a user through an embodiment of the dashboard.

Alert conditions may be determined based on any desired variable. Example variables may include an absolute price difference, a percentage price difference, a gross margin, etc. The alert conditions may be computed based on any desired metric. Example metrics may include the lowest price among competitors in a competitor set, the average price among competitors in a competitor set, etc. In one embodiment, an alert condition maybe met when the price of a competitor's product drops below the price of the same product/product type for a customer. In one embodiment, meeting this alert condition may cause the alert module to notify the customer accordingly. For example, an alert may be generated to notify a customer that a product in a “digital camera” product set has become $1.00 higher than the price of a competitor's price for the “digital camera” competitor set.

Given the sheer size and disparity of data that can be crawled from the Internet across an unbounded number of domains and considering the variability of custom-defined product sets, competitor sets, and rules, it can be extremely complex and challenging to determine if one of the rules has been violated. To address this and other issues, embodiments disclosed herein allow price rules to be hierarchical. The hierarchies of the rules can be defined by a customer and can determine which rules to take precedence over other rules if there is conflicting rules. The rules can be determined based on any desired variable such as an absolute price difference, percentage price difference gross margin, etc. For example, in one embodiment, a price rule may indicate that a customer's price for a product should be $0.01 lower than the lowest price of a product in a competitor set, or a gross margin for a product should be 10% or greater.

Once a price alert condition and/or price rule is defined, the system may determine if the condition is violated and determine desired pricing for the product based on the price rule for which the condition is violated. The system may also: (1) flag or identify the competitor(s) with products that violated the condition for the alert; (2) notify the system's customer to adjust the price of a product associated with the rule; (3) output price recommendations for the product to the customer; and/or (4) automatically adjust the price of the product for the customer.

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of this disclosure, which includes all such substitutions, modifications, additions or rearrangements.

### DESCRIPTION OF THE FIGURES

The drawings accompanying and forming part of this specification are included to depict certain aspects of various embodiments. A clearer impression of these embodiments, and of the components and operation of systems provided with them, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a block diagram of one embodiment of an architecture in which a competitive price alert system with a competitive rules engine may be utilized.

FIG. 2 depicts a flow chart illustrating operation of an example competitive price alert system.

FIGS. 3-6 depict screenshots of an example user interface of an embodiment of a competitive price alert system.

FIGS. 7-8 depict screenshots of an example user interface of an embodiment of a competitive pricing rules engine.

### DETAILED DESCRIPTION

Various features and advantageous the present disclosure are explained more fully with reference to the nonlimiting embodiments that are illustrated in the accompanying drawings and detailed in the following description. Descriptions of well-known starting materials, processing techniques, components and equipment are omitted so as not to unnecessarily obscure the present disclosure. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Before discussing specific embodiments, a brief overview of the context of the disclosure may be helpful. Systems and methods described herein enable customers to create pricing alerts and rules associated with price differences between the prices a customer sells a product and a competitor price of the product. When a price of the competitor's product changes and a specified condition for an alert is violated, a customer may be alerted that their current price for the product is out of a desired range. Customers may also be alerted of a recommended pricing of a product based on a set of hierarchical pricing rules associated with the pricing of the product and/or a margin of the product.

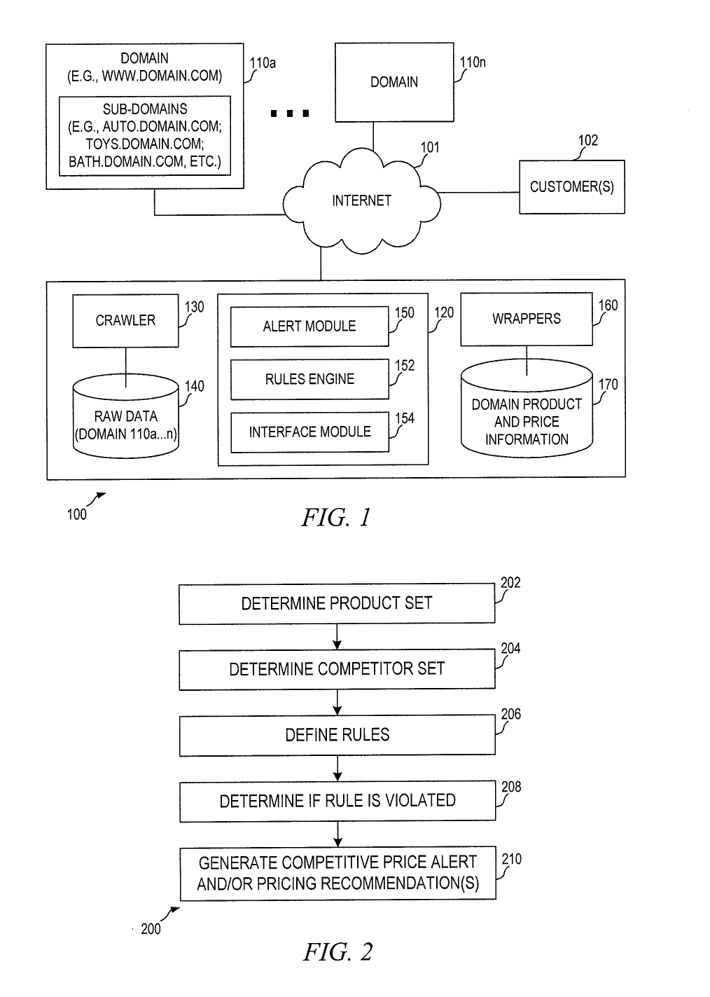

Turning now to FIG. 1, a block diagram illustrating an exemplary system 100 is shown. System 100 couples to a network such as the Internet 101 and has access to domains 110a . . . 110n. Each domain may have a common network name (domain name) under which a collection of network devices are organized (e.g., domain.com). Each domain may have one or more sub-domains (e.g., abc.domain.com, xyz.domain.com, etc.) according to the hierarchical Domain Name System (DNS) of the Internet. The collection of network devices in a domain may include one or more server machines hosting a website representing the domain (e.g., www.domain.com).

A website (also referred to as Web site, web site, or site) refers to a set of related web pages (also referred to as pages) containing content such as text, images, video, audio, etc. A website can be accessible via a network such as the Internet or a private local area network through an Internet address known as a Uniform Resource Locator (URL). All publicly accessible websites collectively constitute the World Wide Web.

Crawler 130 of system 100 may crawl the Internet 101 across domains 110a-110n for data and store them in raw data database 140. The data obtained by crawler 130 may be associated with retail products. Wrappers 160 may be generated using techniques disclosed in Appendix A and/or Appendix B to extract desired information, such as domain product and price information, from the raw data obtained by crawler 130. Other suitable wrapper generation techniques may also be used. The domain product and price information thus obtained may be stored at database 170.

System 100 may include competitive price alert component 120. Component 120 may include alert module 150, rules engine 152, and interface module 154. Functionality of these features will now be described in detail. Alert module 150 may be configured to generate alerts based on customer-defined product sets, competitor sets, and alert rules. For example, customer 102 may define, via a user interface provided by interface module 154, a product set “Digital Cameras” that includes all digital camera products and may define a competitor set “Digital Camera Competitors” that includes all competitors that are relevant to “digital cameras.” Those skilled in the art will appreciate that customer 102 is representative of any and all individuals and entities alike that employ or otherwise consult system 100. Customer 102 may also define, via the user interface provided by interface module 154, alert rules based on absolute price difference, percentage price difference, gross margin, etc. Alert rules can be computed based on the lowest price among the pre-defined competitor group, the average price among the pre-defined competitor group, etc.

Once alert rules are defined by a customer, alert module 150 may check for SKUs or other product identifiers that violate one of the alert rules. In one embodiment, SKUs violating the alert rules can be flagged for easy identification. Customers may choose to receive email alerts when new alerts are detected.

For example, if a condition for a rule has been violated, alert module 150 may operate to notify customer 102. In one embodiment, alert module 150 may operate to generate an email to notify customer 102 that a condition for a rule has been violated. Other notification methods may also be possible. For example, alert module 150 may cause a notification to be generated and presented to customer 102 via interface module 154. In one embodiment, alert module 150 may be configured to run continuously, periodically, or at any other desired time to determine which, if any, condition for an alert associated with a product set is violated. In some embodiments, alert module 150 may be configured to communicate alerts dynamically or on a periodic basis, such as a day, week, month, etc.

Rules engine 152 may be configured to generate pricing recommendations based on customer-defined product sets, competitor sets, pricing rules, and rules hierarchy. For example, customer 102 may define, via a user interface provided by interface module 154, a product set “Digital Cameras” that includes all digital camera products and may define a competitor set “Digital Camera Competitors” that includes all competitors that are relevant to “digital cameras.” Those skilled in the art will appreciate that customer 102 is representative of any and all individuals and entities alike that employ or otherwise consult system 100. Customer 102 may also define, via the user interface provided by interface module 154, pricing rules. For example, customer 102 may define pricing rules for the example product set “Digital Cameras” as “I want the price of my Digital Cameras to be $0.01 lower than the lowest price found among my Digital Camera Competitors” and “I want gross margin on my Digital cameras to be 10% or more.” The user interface provided by interface module 154 can be configured to also allow customer 102 to define a hierarchy of customer-defined pricing rules. For example, customer 102 may define a rules hierarchy as “I want margin rules to always take precedence over pricing rules” and/or “I want rules applied to product categories to always take precedence over rules applied to “all products.”

Once rules and hierarchies are defined by a customer, the pricing rules engine (e.g., rules engine 152) can use this information, together with the competitor prices, to outputs pricing recommendations. In one embodiment, rules engine 152 may be configured to run continuously, periodically, or at any other desired time to generate pricing recommendations based on customer-defined pricing rules and hierarchies.

As described above, a customer of system 100 can interact with system 100 via a user interface provided by interface module 154. Inputs provided by the customer at the front end (e.g., via a web browser running on a client device associated with the customer and implementing an instance of a web based user interface provided by interface module 154) may be communicated to a server machine running system 100 (or a portion thereof, e.g., component 120) at the back end and stored in a data store (not shown) accessible by rules engine 152 and alert module 150.

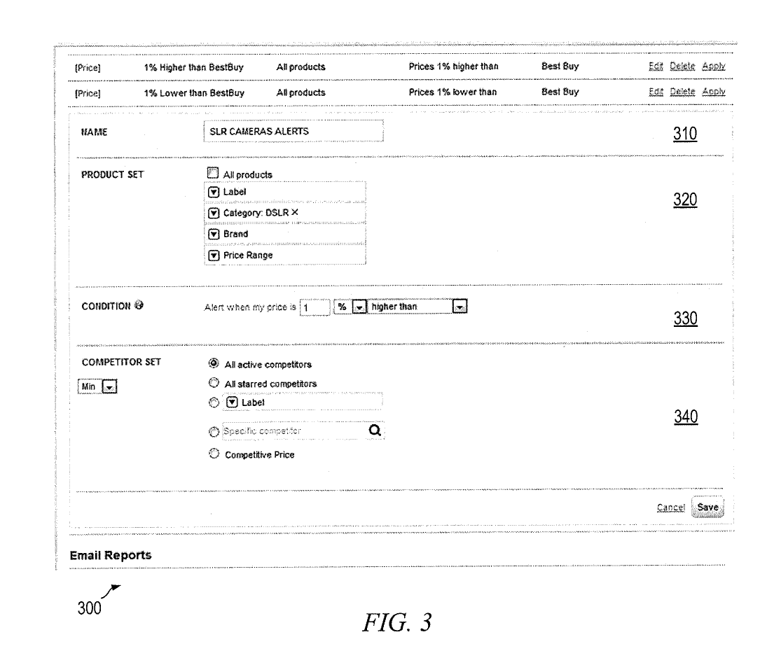

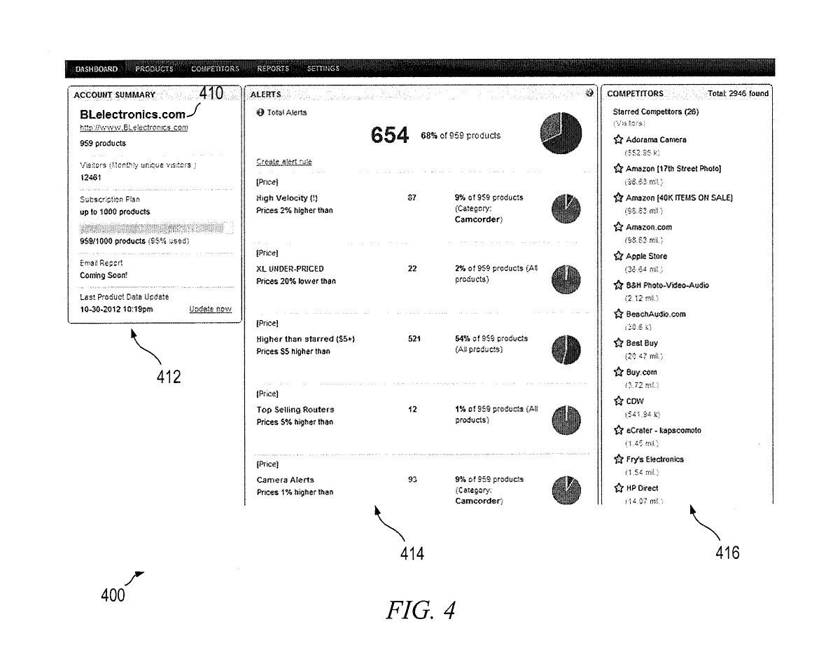

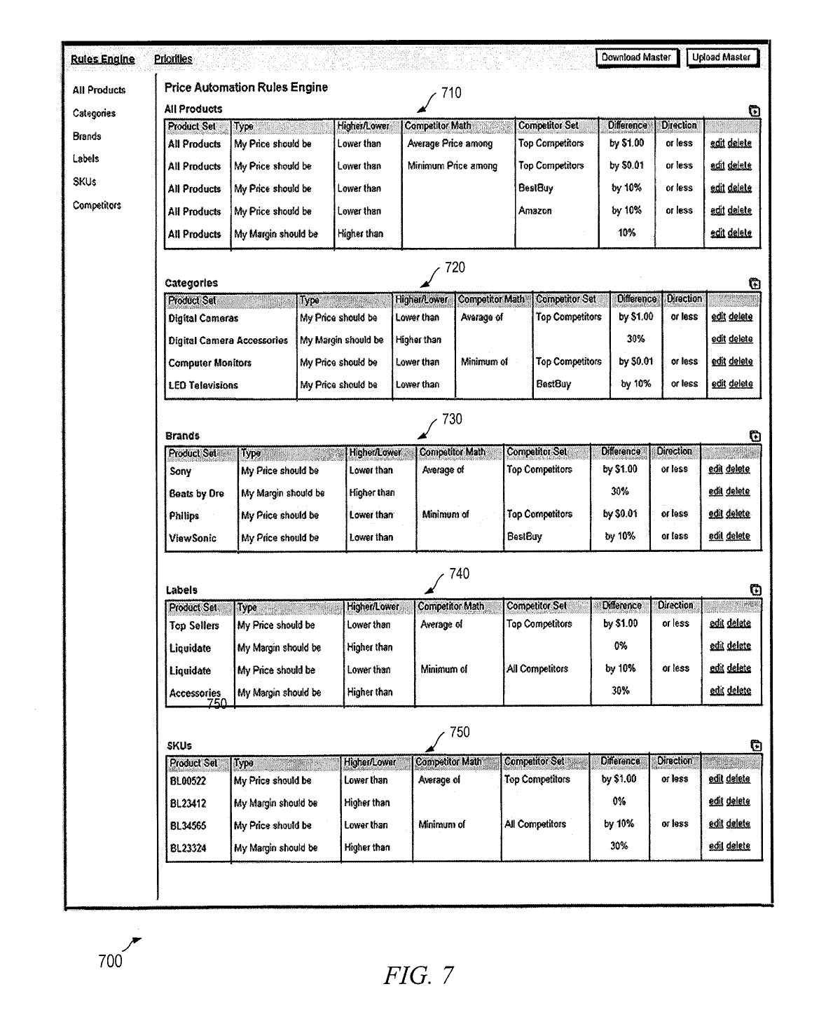

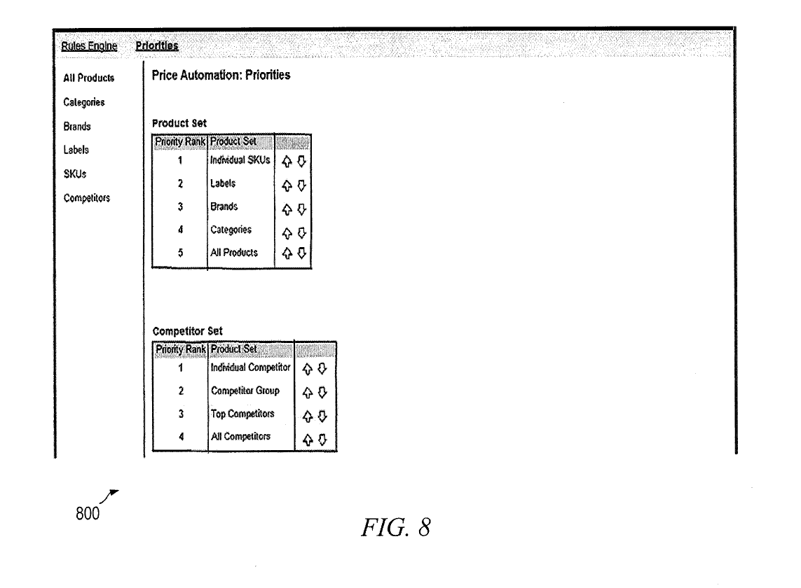

Interface module 154 will now be further described below with references to FIGS. 2-8. More specifically, FIG. 2 depicts a flow chart illustrating operation of an example competitive price alert system. FIGS. 3-6 depict screenshots of an example user interface of an embodiment of a competitive price alert system. FIGS. 7-8 depict screenshots of an example user interface of an embodiment of a competitive pricing rules engine.

At step 202, a customer may determine or identify a product set of interest. The customer may select a product set, for instance, via a user interface. An example user interface is shown in FIG. 3. The product set can be associated with a specific product, a type of product, or all products sold by the customer. As described above, this information can be provided to alert module 150 and pricing rules engine 152 via interface module 154.

At step 204, the customer may determine a competitor set, for instance, via the user interface. The competitor set may be associated with relevant competitors that carry the same products as the customer. Appendix C provides examples of how to match products carried by competitors to products carried by a customer. Other product matching methods may also be used. As described above, this information can also be provided to alert module 150 and pricing rules engine 152 via interface module 154.

At step 206, the customer may define competitive price alert rules and/or pricing rules as described above. As described above, this information can be provided to alert module 150 and pricing rules engine 152 via interface module 154. Each customer-defined rule may be associated with a product within the product set and the same product sold by a competitor in the competitor set. In one embodiment, a condition for an alert rule may be associated with any desired variable such as an absolute price difference, percentage price difference, gross margin, etc. between the customer's product and the competitor's product. Customer-defined rules can include a set of alert rules and a set of pricing rules. The alert rules and pricing rules may be the same, different, or at least partially overlap.

At step 208, it may be determined if a customer-defined rule has been violated. This can include comparing the price of a product in the product set with the price at which a competitor sells the product and determining whether a condition of the rule is no longer true or satisfied. This process may be repeated for each competitor in the competitor set that sells the product.

At step 210, if a customer-defined rule has been violated, appropriate action may be taken. For example, if a competitive price alert rule has been violated, an alert may be communicated to the customer via email or any other mechanism. In one embodiment, the alert may identify specific competitors or all competitors that carry the product triggering the alert. Additionally, a pricing recommendation may be generated. For example, suppose a customer defines an alert rule as “I want the price of my Digital Cameras to be $0.01 lower than the lowest price found among my Digital Camera Competitors.” When this condition is no longer true or satisfied, alert module 150 may notify the customer as described above. Suppose the customer defines the same condition as a pricing rule, pricing rules engine 152 may generate a pricing recommendation based on the customer-defined product set, competitor set, the pricing rule, and any applicable rules hierarchy.

FIGS. 3-8 depict screenshots of an example user interface 300 of an embodiment of a competitive price alert system. Interface module 154 may provide user interface 300 to a client device running a browser application. In this example, user interface 300 includes input areas 310, 320, 330, and 340 for a user to define a name of a price alert, a product set, a rule condition or conditions, and a competitor set.

For example, in alert name input area 310 a customer may enter “SLR CAMERAS ALERTS” as the name of a competitive price alert. The alert name can be arbitrarily defined and may or may not be associated with a specific product or type of products.

In this example, product set input area 320 is configured to allow a customer to select a product set. The selection can be done via a drop down menu or any other selectable menu associated with products sold by the customer. As a non-limiting example, a customer may desire a product set to include all products carried by the customer that are Digital Single-Lens Reflex (DSLR) cameras. In further embodiments, a product set may be defined by a brand or price range associated with a product.

Condition input area 330 may be configured to allow a customer to create a threshold alert value that triggers the generation of an alert and/or pricing recommendation as described above. In one embodiment, a condition may be associated absolute price difference, percentage price difference and/or gross margin between the competitor's product price and the product in the product set.

Competitor set input area 340 is configured to allow a customer to select a set of competitors for which the competitor's products associated with the product(s) selected in the product set will be compared with to determine if the competitor's products violate a condition of an alert. In one embodiment, competitor set input area 340 may be configured to allow a customer to define a competitor set to include all active competitors, a set of predetermined or desired competitors, a customer to manually type desired competitors, and/or select competitors based on competitive pricing.

In some embodiments, user interface 300 may include a customer dashboard providing summary information particular to a customer. FIG. 4 depicts one embodiment of a customer dashboard 400 for customer 410. Customer dashboard 400 may, in this example, include an account summary 412 associated with customer 410, alerts summary 414, and competitors summary 416. Account summary 412 may include a number of the products carried by customer 410, a number of unique visitors that viewed a website associated with customer 410 over a time period, subscription plan data associated with customer 410, and a time indicator associated with the last time product alerts were determined.

Alerts summary 414 may be configured to display rules defined by customer 410 and alerts associated with a product set defined by customer 410. Alerts summary 414 may indicate a total number of products in the product set that violate a condition associated with a rule defined by customer 410 and/or a percentage of products in the product set that violate a condition associated with the rule. Alerts summary 414 may also indicate a percentage of and/or a total number of products in the product set that violate a specific condition associated with a rule defined by customer 410.

Competitors summary 416 may indicate competitors in a competitor set and a number of visitors that viewed a competitor's website over a given time period. Competitors summary 416 may be configured to display a list of competitors in many ways. In this example, competitors summary 416 may be configured to display a list of competitors that customer 410 has indicated as relevant competitors. The list of competitors can be sorted in various ways. For example, competitors summary 416 may be configured to display a list of relevant competitors by order of relevance, by the number of unique visitors, or in an alphabetical order. Other sorting methods may also be possible.

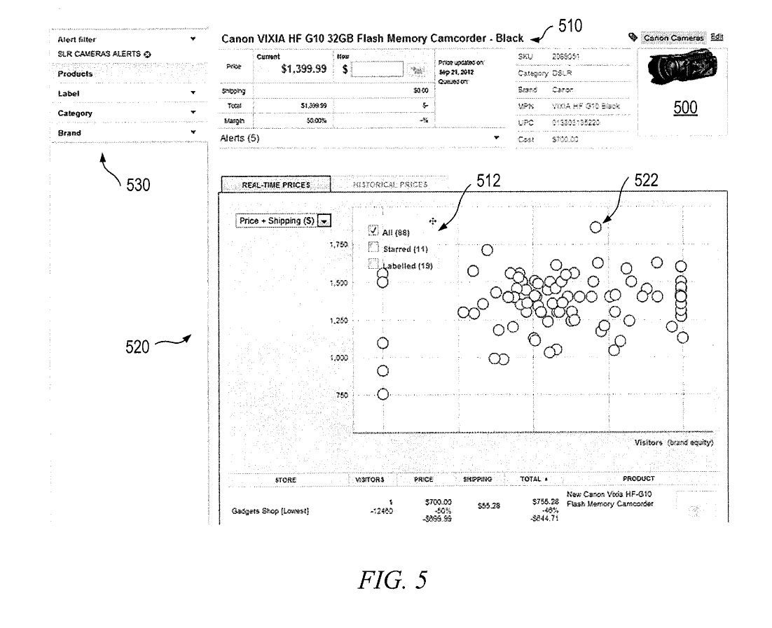

An authorized user of customer 410 can view details associated with a specific alert on alerts summary 414 in various ways. One example view is depicted in FIG. 5. FIG. 5 shows an example product “Canon® VIXIA HF G10 32 GB Flash Memory Camcorder—Black” 510 in a product set “Canon® Cameras” 500. In this example, there are 88 competitors in a competitor set 512, of which 11 competitors are considered relevant (e.g., as indicated by “Starred”). The example view shown in FIG. 5 includes a graph 520 visually displaying each of the competitors by the number of their visitors relative to the price (plus shipping in this example) of the matching product carried by the competitor. This is shown in graph 520 as a data point 522. Each point 522 is associated with a different competitor selling the same (matching) product.

In this example, the X axis of graph 520 indicates the brand equity of different competitors. Competitors with lower X axis values have fewer unique visitors to their website, and competitors with higher X axis values have higher unique visitors to their website. The Y axis of graph 520 may indicate a price associated the product.

If a competitor changes a price associated with the product, the data point associated with that competitor can be adjusted accordingly on graph 520. As described above, this change may trigger or avoid an alert.

As shown in FIG. 5, a filter area 530 may be provided to allow an authorized user of a customer to adjust or change data points 522 displayed on graph 520. Each filter may be associated with a competitor set. Using a filter a customer may determine which sets of competitors they desire to have data points 522 displayed on graph 520. Filter area 530 may include filters associated with all competitors or a set of competitors that the customer had previously starred and/or labeled as a competitor set. If a filter is set to view all competitors, then an unbound set of data points associated with competitors selling the product that violated a condition for an alert may be displayed on graph 520.

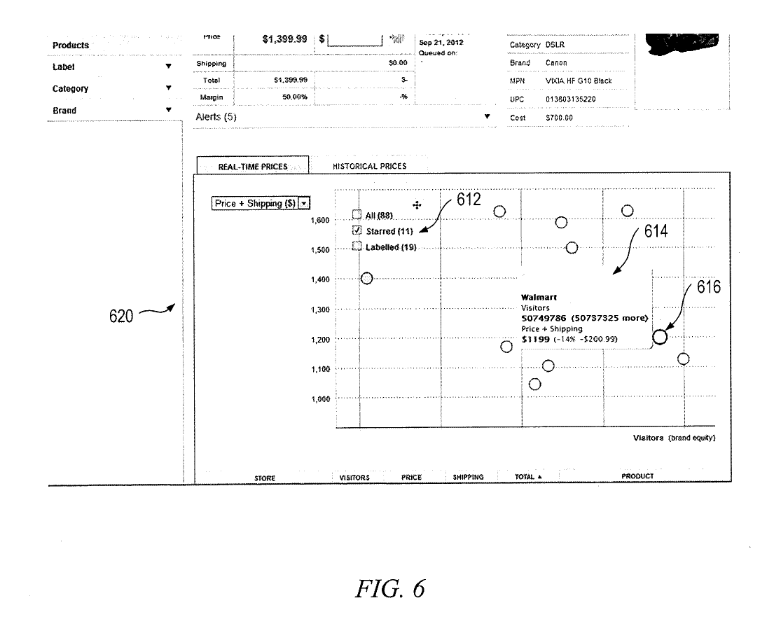

FIG. 6 depicts an example when a filter is set to display “Starred” competitors. In this case, graph 620 shows only relevant competitors 612. When a user viewing graph 620 hovers or selects a data point 616 on graph 620, specific information about relevant competitor 612 is displayed in a box 614. Other display methods may also be used.

Those skilled in the art will appreciate that the above-described example user interface shown in FIGS. 3-6 for a competitive price alert system can be implemented in various ways. Likewise, the example user interface shown in FIGS. 7-8 and described below for a competitive pricing rules engine can be implemented in various ways. Thus, examples depicted in FIGS. 3-8 are meant to be illustrative, rather than limiting.

Rules engine interface 700 may include rules associated with different product sets such as, all products 710 including all products that a customer carries, categories of products 720, brands 730, labels 740 associated with attributes of a product that are defined by the customer, and SKUs 750 associated with a single product. In one embodiment, each product set may include one price rule and one margin rule.

For each product grouping, rules engine interface 700 may include a product set identifying which products are in the grouping, the type of rule indicating whether the rule is associated with a price, margin, etc. of the consumer's product(s), a higher/lower value indicating if the price for the consumer's product(s) should be higher/lower than the a given value, competitor math associated with what metric should be used for the rule, a competitor set associated with what competitors a rule applies to, a difference value associated with a threshold that the pricing of the customer's price, margin, etc. of a product should be, and a direction value associated with a qualifier for the rule.

Rules engine interface 700 may allow a customer (e.g., an authorized user of a business entity that employs or consults system 100) to set priorities. FIG. 8 depicts one embodiment of a rules engine interface 800 configured to allow a user to set priority values for various groupings associated with a particular product set and a corresponding competitor set. These priority values can be used to determine which rules for a product set or competitor set are given precedence if different rules conflict or overlap. For example, in one embodiment, rules associated with individual SKUs may be given priority over rules associated with all products. Other implementations may also be possible.

Although the present disclosure has been described in terms of specific embodiments, these embodiments are merely illustrative, and not restrictive. The description herein of illustrated embodiments, including the description in the Abstract and Summary, is not intended to be exhaustive or to limit the disclosure to the precise forms disclosed herein (and in particular, the inclusion of any particular embodiment, feature or function within the Abstract or Summary is not intended to limit the scope of the disclosure to such embodiments, features or functions). Rather, the description is intended to describe illustrative embodiments, features and functions in order to provide a person of ordinary skill in the art context to understand the present disclosure without limiting same to any particularly described embodiment, feature or function, including any such embodiment feature or function described in the Abstract or Summary. While specific embodiments are described herein for illustrative purposes only, various equivalent modifications are possible, as those skilled in the relevant art will recognize and appreciate. As indicated, these modifications may be made in light of the foregoing description of illustrated embodiments and are to be included within the spirit and scope of the disclosure. Thus, various changes and substitutions are intended in the foregoing disclosures, and it will be appreciated that in some instances some features of embodiments will be employed without a corresponding use of other features without departing from the scope and spirit as set forth. Therefore, many modifications may be made to adapt a particular situation or material.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein.

In the description herein, numerous specific details are provided, such as examples of components and/or methods, to provide a thorough understanding of described embodiments. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments. A person of ordinary skill in the art will recognize that additional embodiments are readily understandable from the disclosure.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the described embodiments.

It is also within the spirit and scope of the disclosure to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. Various embodiments may be implemented by using software programming or code in one or more general purpose digital computers, by using application specific integrated circuits, programmable logic devices, field programmable gate arrays, optical, chemical, biological, quantum or nanoengineered systems, or components and mechanisms may be used. In general, the functions of various embodiments can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

1. A method for providing competitive price alerts, the method comprising:
generating a product set from product information received from a user;
generating a competitor set, the competitor set comprising at least one competitor offering at least one product in the product set;
generating a rule set, the rule set comprising at least one rule applied to the at least one product and the at least one competitor;
searching the at least one product against the at least one competitor to determine if the at least one rule has been broken; and
transmitting an alert in response to determining the at least one rule has been broken.

2. The method of claim 1, wherein determining if the at least one rule has been broken comprises:
comparing a price offered by the user for the at least one product to a price offered by the at least on competitor for the at least one product; and
based on the comparison, determining if a condition of the rule is not satisfied.

3. The method of claim 2, wherein determining if a condition of the rule is not satisfied comprises:
determining if a difference in price offered by the user and price offered by the at least one competitor is greater than a threshold value.

4. The method of claim 2, wherein the condition of the rule comprises at least one of:
absolute difference in price offered by the user and price offered by the at least one competitor;
percentage of difference in price offered by the user and price offered by the at least one competitor; or
gross margin difference in price offered by the user and price offered by the at least one competitor.

5. The method of claim 1, further comprising:
prioritizing rules comprising the rule set;
wherein transmitting an alert in response to determining the at least one rule has been broken comprises transmitting an alert that the highest priority rule has been broken.

6. The method of claim 1, wherein the at least one rule comprises:
a price rule generated from pricing information received from a user;
wherein transmitting an alert in response to determining the at least one rule has been broken comprises transmitting an alert in response to determining the price rule has been broken.

7. The method of claim 1, wherein the rule set comprises:
a prioritized set of price rules;
wherein transmitting an alert in response to determining the at least one rule has been broken comprises transmitting an alert that the highest priority price rule has been broken.

8. The method of claim 1, further comprising:
generating a recommendation to correct the at least one broken rule.

9. The method of claim 8, wherein generating a recommendation to correct the at least one broken rule comprises:
generating a recommendation to lower the price of the at least one product.

10. The method of claim 1, further comprising:
receiving instructions to modify the competitor set, the instructions comprising an instruction to prioritize competitors.

11. The method of claim 1, further comprising:
receiving instructions to modify the competitor set, the instructions comprising an instruction to prioritize competitors in the competitor set.

12. A system for providing competitive price alerts, the system comprising:
a memory; and
a processor, the processor configured to:
generate a product set from product information received from a user;
generate a competitor set, the competitor set comprising at least one competitor offering at least one product in the product set;
generate a rule set, the rule set comprising at least one rule applied to the at least one product and the at least one competitor;
search the at least one product against the at least one competitor to determine if the at least one rule has been broken; and
transmit an alert in response to determining the at least one rule has been broken.

13. The system of claim 12, wherein the processor is further configured to:
compare a price offered by the user for the at least one product to a price offered by the at least on competitor for the at least one product; and
based on the comparison, determine if a condition of the rule is not satisfied.

14. The system of claim 13, wherein the processor is further configured to:
determine if a difference in price offered by the user and price offered by the at least one competitor is greater than a threshold value.

15. The system of claim 13, wherein the condition of the rule comprises at least one of:
absolute difference in price offered by the user and price offered by the at least one competitor;
percentage of difference in price offered by the user and price offered by the at least one competitor; or
gross margin difference in price offered by the user and price offered by the at least one competitor.

16. The system of claim 12, wherein the processor is further configured to:
prioritize rules comprising the rule set;
wherein transmitting an alert in response to determining the at least one rule has been broken comprises transmitting an alert that the highest priority rule has been broken.

17. The system of claim 12, wherein the processor is further configured to:
generate a price rule from pricing information received from a user;
wherein transmitting an alert in response to determining the at least one rule has been broken comprises transmitting an alert in response to determining the price rule has been broken.

18. The system of claim 12, wherein the processor is further configured to:
prioritize a set of price rules comprising the rule set;
wherein transmitting an alert in response to determining the at least one rule has been broken comprises transmitting an alert that the highest priority price rule has been broken.

19. The system of claim 12, wherein the processor is further configured to:
generate a recommendation to correct the at least one broken rule.

20. The system of claim 19, wherein the processor is further configured to:
generate a recommendation to lower the price of the at least one product.

21. The system of claim 12, wherein the processor is further configured to:
receive instructions to modify the competitor set, the instructions comprising an instruction to prioritize competitors.

22. The system of claim 12, wherein the processor is further configured to:
receive instructions to modify the competitor set, the instructions comprising an instruction to prioritize competitors in the competitor set.
